(19) United States
(12) Patent Application Publication
(10) Pub. No.: US 2005/0119937 A1
(43) Pub. Date: Jun. 2, 2005

(54) Method and system for generating and managing referrals

(76) Inventor: Anthony D. Estes, Waltham, MA (US)

Correspondence Address: GREENBERG TRAURIG, LLP, One International Place, Boston, MA, 02110, US

(21) Appl. No.: 10/835,200

(22) Filed: Apr. 28, 2004

Related U.S. Application Data
(60) Provisional application No. 60/517,956, filed on Nov. 6, 2003.

(51) Int. Cl. G06F 17/60

(52) U.S. Cl. 705/14

(57) ABSTRACT

A method and system for generating and managing referrals is provided. Specifically, a system is provided for rewarding an originator of a referral which results in participation by the recipient of the referral in a defined event. The system employs various messaging events to encourage referrals from an originator of referrals and participation by the recipients of the referrals in a defined event.

### RELATED APPLICATIONS

This application claims benefit of priority to U.S. provisional application Ser. No. 60/517,956, filed on Nov. 6, 2003, the contents of which are hereby incorporated herein by reference in its entirety.

### FIELD OF THE INVENTION

The present invention is directed to a method and system for generating and managing referrals. Specifically, the present invention provides a method of rewarding an originator of a referral which results in participation of the recipient of the referral in a defined event.

### BACKGROUND OF THE INVENTION

Increasing competitiveness in the marketplace has required businesses to increase productivity and expand the types of services and goods they provide to the marketplace. In turn, consumers of products and services are faced with increased difficulties in efficiently selecting from amongst a wide-variety of product offerings. Traditional methods of reaching, informing, and persuading a potential customer, e.g., direct mail and telemarketing, are often not very efficient. It has been difficult and time-consuming to identify and value a population of consumers suited to direct marketing approaches. Telemarketing techniques such as cold-calling, have declining success rates due, in part, to technological measures such as caller-ID, call-blocking, and the like. Privacy regulations provide a further barrier to product and service providers to employ direct marketing.

New marketing economics are associated with the emergence of new marketing channels. Low-variable-cost, direct communications channels-like e-mail, The Short Message Service (hereinafter, “SMS”), Multimedia Messaging Service (hereinafter, “MMS”) and others may be utilized to market goods and services. Companies seek a competitive advantage in the marketplace with new approaches that allow them to identify and manage their customers.

Every marketer knows that the best sales person is a satisfied customer. Satisfied customers talk and their words are emotionally powerful, projecting a sense of opportunity to share immediate benefit of a product or service already vetted by others. A consumer (“Referree”) is much more likely to purchase goods and services based on a referral from someone (“Referrer” or “Originator”) he knows and trusts. When the Originator is also a known person of known stature, the power of the selection by that person is even more powerful.

There remains a need for efficient and economical methods to systematically generate and manage referrals.

### SUMMARY OF THE INVENTION

The present invention provides, in one embodiment, a method for generating electronic referrals. The method includes, among other things, transmitting to a participating recipient an electronic message that contains therein an incentive, so as to encourage the participating recipient to provide contact information of at least one referree recipient having an identified interest similar to that of the participating recipient. The incentive, in one embodiment, includes a reward redeemable upon participation by the referree recipient in the invited event. Once the message is transmitted, based on the response from the participating recipient, a database of contact information of referree recipients may be generated. Before the contact information is generated within the database, the contact information may be validated to determine whether it is a duplicate or whether it contains incorrect data. Thereafter, an electronic message formatted to appear as a message from the participating recipient may be forwarded to each referree recipient with an invitation to participate in an event for which the participating recipient is a participant. Should the referree recipient participates in the invited event, the participating recipient may be notified of such the referree's participation and a redeemable reward is allocated to the participating recipient. The method, in accordance with one embodiment of the invention, provides the referree recipient who participates in the invited event to provide contact information of other referree recipients, with an opportunity to receive a redeemable reward in the event those other referree recipients participates in the invited event.

In another embodiment of the present invention, a method for referral is provided. The method includes transmitting to a participating recipient an electronic message that contain therein an incentive so as to encourage the participating recipient to provide contact information of at least one referree recipient having an identified interest similar to that of the participating recipient. The incentive, in one embodiment, includes a reward redeemable upon participation by the referree recipient in the invited event. Thereafter, an electronic message formatted to appear as a message from the participating recipient may be forwarded to each referree recipient with an invitation to participate in a first of a series of events. For instance, the referree recipient may be invited for a free trial before purchasing. Subsequently, a message with an invitation to participate in the next sequential event may be sent upon participation of the referree recipient in the first event. The referree recipient in this embodiment may be one individual or multiple members on a committee, each with a distinct roll and decision power along the series of event. Should the referree recipient participates in each of the series of invited event, the participating recipient may be notified of the referree's participation and a redeemable reward is allocated to the participating recipient. In the event there are multiple committee members, the method of the present invention, may allocate a redeemable reward to each referree recipient along the series of events should his participation results in a subsequent participation by the next referree recipient in the series of events.

### BRIEF DESCRIPTION OF THE DRAWINGS

The present invention will be further understood from the following description with reference to the figures, in which:

FIG. 1 shows a flow-chart illustrating a method for a referral process in accordance with one embodiment of the present invention.

FIG. 2 shows a detailed illustration of an initial communication transmitted to an Originator.

FIG. 3 shows a detailed illustration of a communication transmitted to an Originator for the input of new Referree contact information.

FIG. 4 shows a detailed illustration of a communication transmitted to an Originator with notification of invalid contact information for a Referree and other previously captured referrals.

FIG. 5 shows a detailed illustration of a communication transmitted to an Originator confirming new referrals and potential value of a reward to the Originator.

FIG. 6 shows a detailed illustration of a “faux-forward” communication transmitted to a Referree.

FIG. 7 shows a detailed illustration of a communication transmitted requesting additional contact information associated with a Referree and to permit the Referree to proceed with the participation process.

FIG. 8 shows a detailed illustration of a summary communication transmitted to a Referree summarizing certain contact information associated with the Referree prior to initiating the participation process.

FIG. 9 shows a detailed illustration of a confirming communication transmitted to a Referree in response to his participation in the event.

FIG. 10 shows a flow-chart illustrating a referral process in accordance with one embodiment of the present invention

### DETAILED DESCRIPTION OF SPECIFIC EMBODIMENTS

The present invention, in one embodiment, is directed to a method and system for generating and managing referrals. The present invention provides direct referral-based marketing, that is predictable and scalable, and that is capable of seizing efficiencies and features of multiple communication channels. The present invention may be applied for either commercial or non-commercial purposes.

In accordance with one embodiment, the present invention employs an electronic channel centered platform based on internet applications such as e-mail and the world wide web to stimulate and manage the responses of communities of Originators and Referrees. An Originator, in one embodiment of the present invention, may be an individual or entity that refers another individual or entity, e.g., business, by supplying the identity and/or contact information of the individual or entity. A Referree, on the other hand, may be an individual or entity identified by an originator to receive a communication. The present invention, in an embodiment, provides a means of rewarding an originator of a referral when the referral results in the participation by the Referree in a defined event. For example, when a Referree becomes a customer, the Originator is rewarded ratably. The manner in which an Originator benefits in the incremental growth in economic value among the community of Referrees varies with the product or service sold; its price; the number and relationships between those involved with the purchase process. In addition, the present invention provides, in an embodiment, an Originator a reason and a means to introduce new customers or prospects on electronic channels, such as electronic mail or the world wide web, where barriers to introductions are low and where the marginal costs of such communications are essentially free, and where things can happen quickly. The present invention also provides, in one embodiment, a mechanism where Referrees can be nurtured from the initial introduction through to a beneficial action or defined event, e.g., the purchase of a product or service, in accordance with a rule-based, interactive web-based system that delivers one or more messages to the Referrees, for example, on his display terminal. The invention enables, in accordance with an embodiment, social networking and value exchange by proscribing, accounting for, and managing the issuance of a system of financial rewards for both the Originator and the Referree in each referral transaction. The result can be that providers of a good or service can extend their business and grow their customer base very quickly, while only paying a fraction of what they get value wise incrementally.

The social networking provided by the present invention, in one embodiment, can also functionally be a partnership marketing approach, with a company and an Originator collaborating to market a product or service to the right people. Moreover, connectedness factors can be provided as an implicit function of the invention. Specifically, such factors can provide a commercially-oriented social network and can be presented as data inputs into the system (e.g., applications, data, rules, analytical models). For instance, if the Originator refers a Referree, and other Originators also refer the same Referree, to a degree, that is of social significance. The system, accordingly, elevates its attention to acquiring that particular Referree, using appropriate increases in investment of time, frequency and offer/premium. Social network, growth, measurement, and optimization, therefore, are important facets of the overall control model for the present invention.

Furthermore, the present invention, in one embodiment, utilizes a referral engine that has a manual linkage to the fulfillment systems and processes to relate and define activities therein to entry states and behaviors of independent downstream systems. In another embodiment of the invention, the referral engine is semi-automatic, having a mix of manual and automatic mechanisms to relate its economy and defining activities therein to entry states and behaviors of independent downstream systems. In yet another embodiment of the invention, the referral engine of the method and system of the invention has an automatic linkage between one or more downstream systems and various points-of-entry and entry states.

Recruiting an Originator

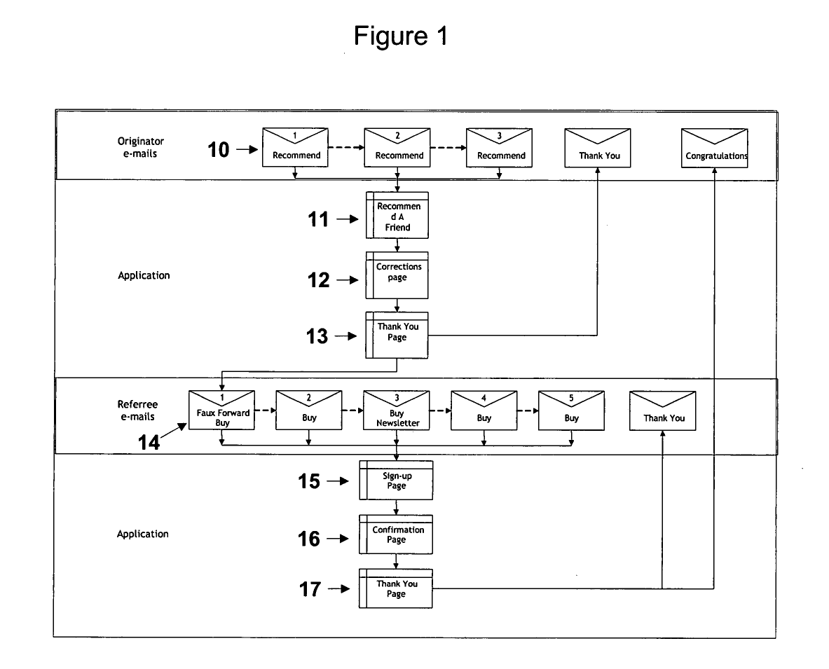

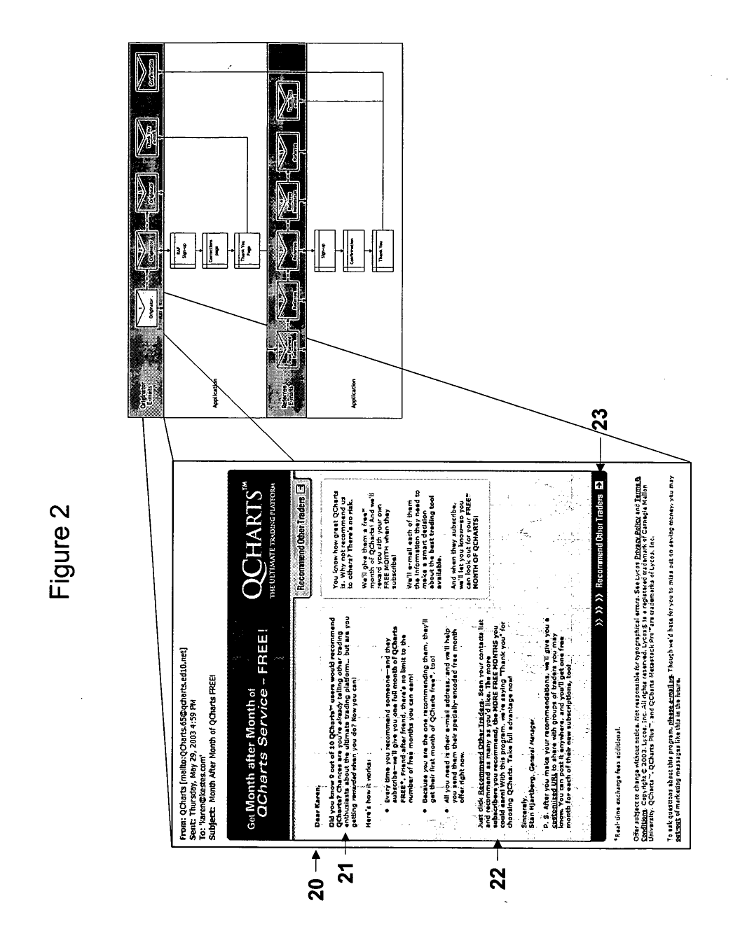

Referring now to FIG. 1, initially a communication, such as an electronic communication or message (e.g., email), may be forwarded Step 10 to a participating recipient (i.e., Originator) and displayed on a medium, for example, a computer display or hand-held personal device, in which he can review. The communication 20, as illustrated in FIG. 2, may contain therein a message 21 encouraging the Originator to provide the contact information, such as an electronic mail address, of referree recipients (i.e., Referree) who may be interested in participating in an event in which the Originator is a participant. The event can be, for instance, subscription to an on-line newsletter, membership to a certain organization, purchasing a product or service, signing up for a seminar, or any commercially or non-commercially related event wherein viability of the event is dependent on the growth in membership or customers. In order to encourage and entice the Originator to provide such information, the message 21 may offer a reward 22 to the Originator and which may be redeemable upon participation by any of the Referrees in the event. In the event the Originator fails to respond to the initial communication 20, additional or follow-on communications (not shown) may be transmitted to the Originator to encourage a response. These follow-on communications may continue in a “sticky state”, that is the follow-on messages to the recipient may continue to occur, until recipient interaction is detected or inferred. The order, type and frequency of the follow-on communications transmitted to the Originator can be defined by a rule-based program within the present invention. In one embodiment, the order, type and frequency of the electronic communications delivered to the Originator's display may be dependent on a response, e.g., opening the e-mail or other action, by the Originator.

Various rule-based processing techniques may be employed in connection with the referral process of the present invention. In accordance with one embodiment, “simple rules” may be implemented. Such “simple rules” include basic expressions and constraints, such as regulating permissible communication such that it can occur on business days between certain hours in certain time zones. Alternatively, “complex rules” may be implemented in connection with the referral process of the present invention. One type of “complex rules” employs “expert system” techniques, such as rule chaining. In one embodiment, an “expert system” technique incorporates a number of state of the art techniques to encapsulate generalized knowledge and linking observations between domains of possible and ranges of outcomes. This can be an essential mechanism for the accumulation and expression of learning during operation of the referral process of the present invention. Another type of “complex rules” employs “analytics-based” techniques, e.g., linear and non-linear, including neural, in connection with the referral process of the present invention. In an embodiment, analytical models of various types can help to react in continuous manners to non-linear-distinctive relationships between the domain of events detected and the range of available reactions to those events located on a non-linear estimation of various continuous functions.

Capturing, Sorting, and Correcting Referree Contact Information

Should the Originator decide to take up the offer to provide the contact information of the Referrees, for instance by clicking on a link 23 provided in the message 21, a second communication may be transmitted (Step 11 in FIG. 1) to the Originator in order to capture the contact information to be provided by the Originator.

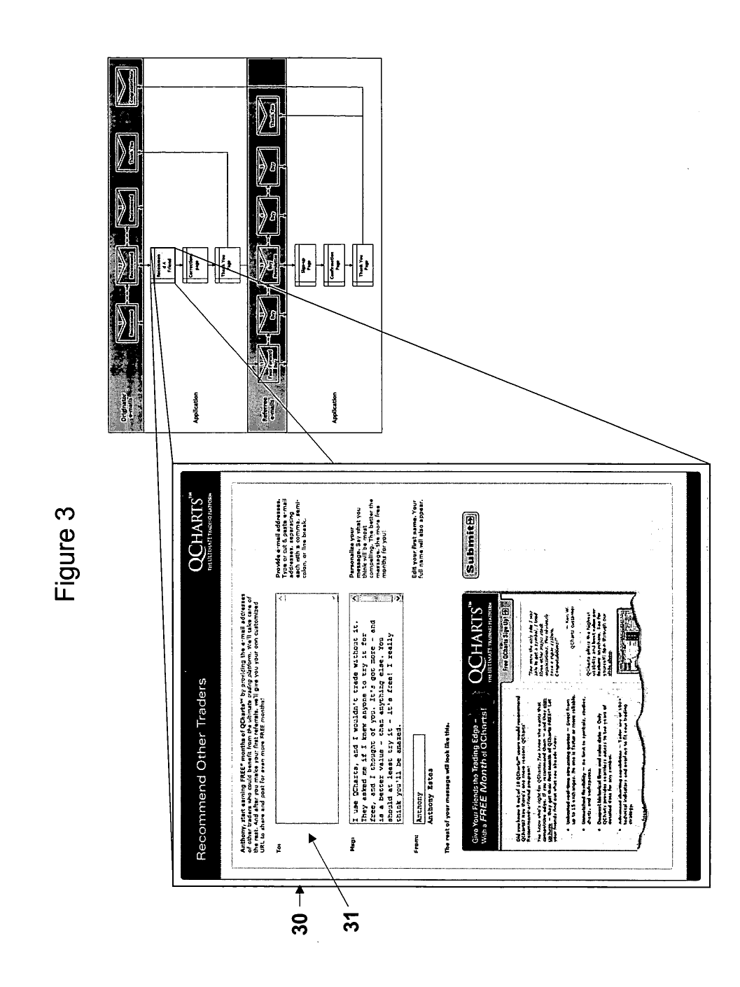

Looking now at FIG. 3, a second communication 30 may be provided on the Originator's display to permit the Originator to input the contact information, e.g., e-mail address, residential address, or phone number of certain Referrees into, for instance, field 31. Once the Referree's contact information is submitted, it may be assessed to determine whether it is valid identifying information or whether it contains incorrect data. The Referree's identifying information may also be compared with other Referree's previously captured and stored in a database. If the contact information is of a current customer, i.e., one that already exists in the database, such contact information may be excluded and not entered and stored in the database. It should be noted that at the early stages of the data generation for the database, a “first-person-in-referring” can be an aggressive network expansion setting. In this manner, such a protocol can ensure that if the incentives are right for a given Originator, that each batch of submissions can be maximally expansive. In other words, regardless of volume referred, the database has the greatest tendency to expand.

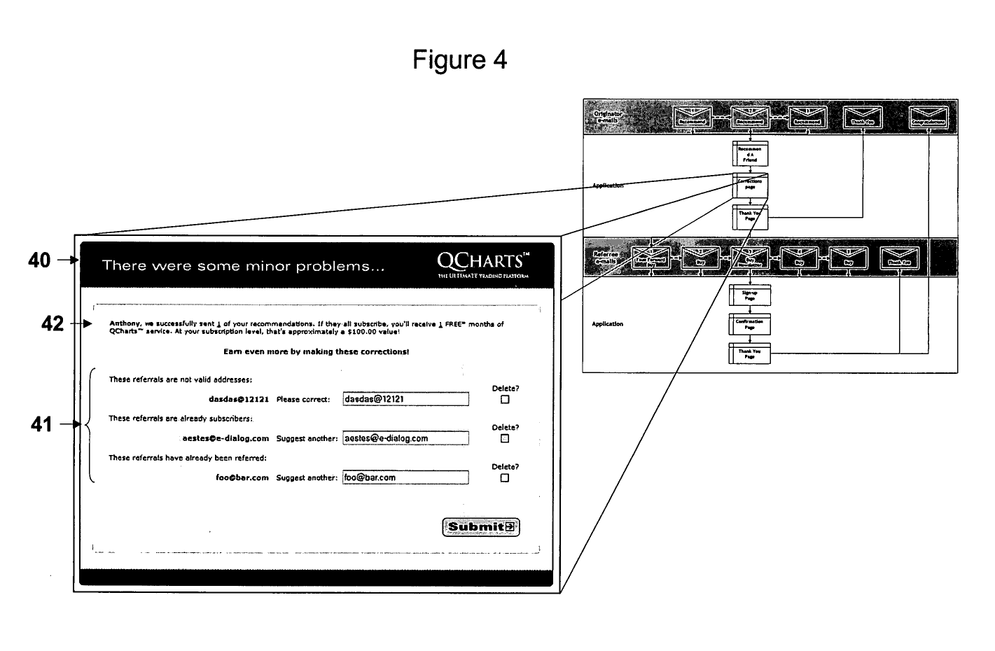

In the event the contact information provided by the Originator contains incorrect or invalid data, or that the contact information already exists in the database, a notification may be transmitted (Step 12 in FIG. 1) to the Originator. As illustrated in FIG. 4, a notification communication 40 may be transmitted to the Originator notifying the Originator with a listing 41 of those Referrees or contact information that is invalid or that is currently in the database. The communication 40, in one embodiment, provides the Originator with an opportunity to correct the Referree contact information and resubmit it for inclusion to the Referree database. To encourage correction of the contact information for resubmission, the communication 40 may contain a message 42 that reminds the Originator of the reward that can be redeemed upon participation by the Referree whose contact information is currently incorrect.

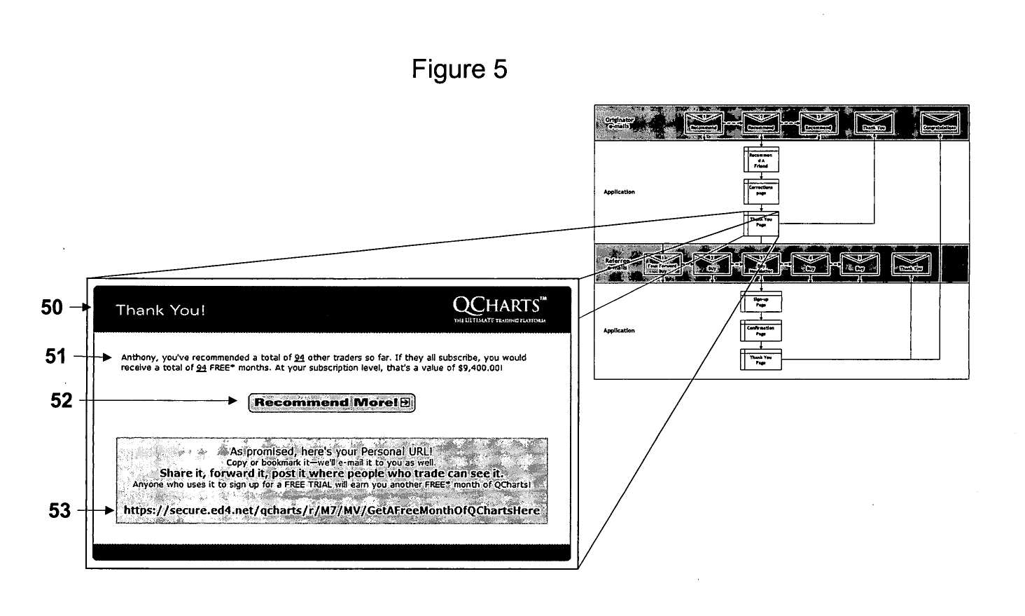

Once the corrections have been submitted in response to the notification communication 40, and upon completion of the referral submissions by the Originator, a “Thank You” communication may be transmitted (Step 13 of FIG. 1) to the Originator. As shown in FIG. 5, upon completion of the referral capture, correction and sorting, a “Thank You” communication 50 may be transmitted to the Originator along with a summary 51 of the number of validated Referrees from that Originator that have been recorded in the database. The summary 51 may also include a calculated potential value of the reward that is redeemable should all the Referrees from that Originator decide to participate in the event. The communication 50, as shown in FIG. 5, may also include a link 52 that provides the Originator with an opportunity to provide contact information of additional Referrees.

In accordance with one embodiment of the present invention, the communication 50 may also provide the Originator with a customized URL link 53. The customized URL link 53 may be a personalized uniform resource locator that can be posted, shared or distributed electronically by the Originator. In connection with the link 53, anyone who accesses the customized URL link 53, and subsequently participates in the event which the Originator is a participant will act to trigger a redeemable reward credit to the Originator. This customized URL link 53, in an embodiment, can also provide a means for distributing a marketing initiation activity between a company and an Originator beyond the referring sessions the Originator himself originates.

Referree Development

Looking again at FIG. 1, following the validation and recordation of the Referree contact information in the database, an initial communication may be transmitted (Step 14) to the Referree and displayed on a medium, for example, a computer display or hand-held personal device, in which the Referree can review.

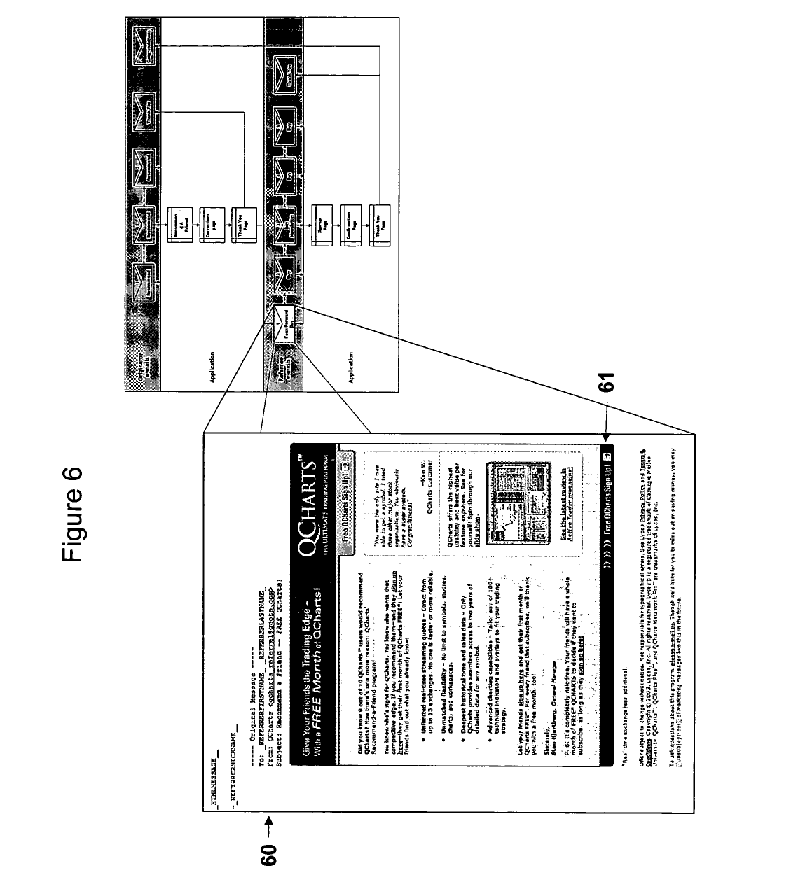

Referring now to FIG. 6, communication 60 may be transmitted to a Referree having the contact information provided by the Originator. The communication 60, in one embodiment, may be formatted to appear as though it is a message from the Originator with most all of the content from the initial communication transmitted to the Originator. Such a format, i.e., “faux-forward”, is purposefully generated to appear as a forwarded message from the Originator to solicit a beneficial action from the Referree. This “faux-forward” communication 60, in one embodiment of the invention, is an invitation to the Referree to participate in the event in which the Originator is a participant and a tailored expression to generate personal connection to the Originator. In other words, it simulates a level of personal intimacy between Sender and Receiver at par with the best manually crafted messages. For example, the communication 60 may look like and behave like in every way a truly forwarded communication, from its visual appearance to the content of its enclosing introductory message, to its interior addressing. This can be a critical bond-builder, since it allows the Referree to associate this first communication as being from a friend not a sales person. This approach can enable a rich stream of communication to follow. In one embodiment, even a reply from the Referree to this communication 60 will route back to the Originator who originated it to, again, empower the involved parties as a partner in the social marketing exercise. The initial, and some or all of communications between Originator and Referrees may be designed in this manner.

In the event the Referree fails to respond to the communication 60, additional or follow-on communications (not shown), which may not necessarily be a “faux-forward” communication, may be transmitted to the Referree to encourage a response. As with the follow-on communications to the Originator, the follow-on communications to the Referree may remain in a “sticky state” until recipient interaction is detected or inferred. The order, type and frequency of the follow-on communications transmitted to the Referree can be defined by a rule-based program within the present invention. In one embodiment, the order, type and frequency of the communications delivered to the Referree's display may be dependent on a response, e.g., opening the e-mail or other action, by the Referree. The rule-based program employed may be similar to those discussed above in connection with Originator.

Should the Referree decide to respond to the communication 60, for instance by clicking on a link 61 provided in the communication 60, a second communication may be transmitted (Step 15 in FIG. 1) to the Referree in order to provide the Referree with an opportunity to participate in the invited event.

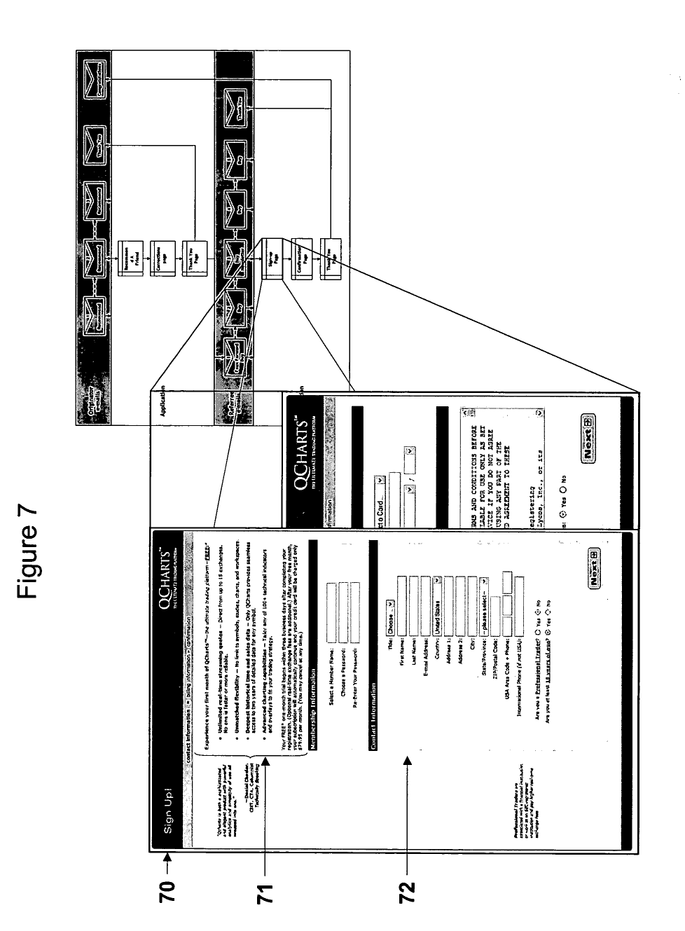

As shown in FIG. 7, a communication 70 may be transmitted to the Referree to permit the Referree to complete the process for participation in the invited event. As part of this process, communication 70, in one embodiment, may include a message 71 to encourage the Referree to participate in the invited event. The communication 70 may also the include a request 72 for additional contact information from the Referree. As shown, in FIG. 7, the request 72 may be tied in with the message 71 encouraging the Referree to participate in the event. The communication 70 may also include payment options (not shown).

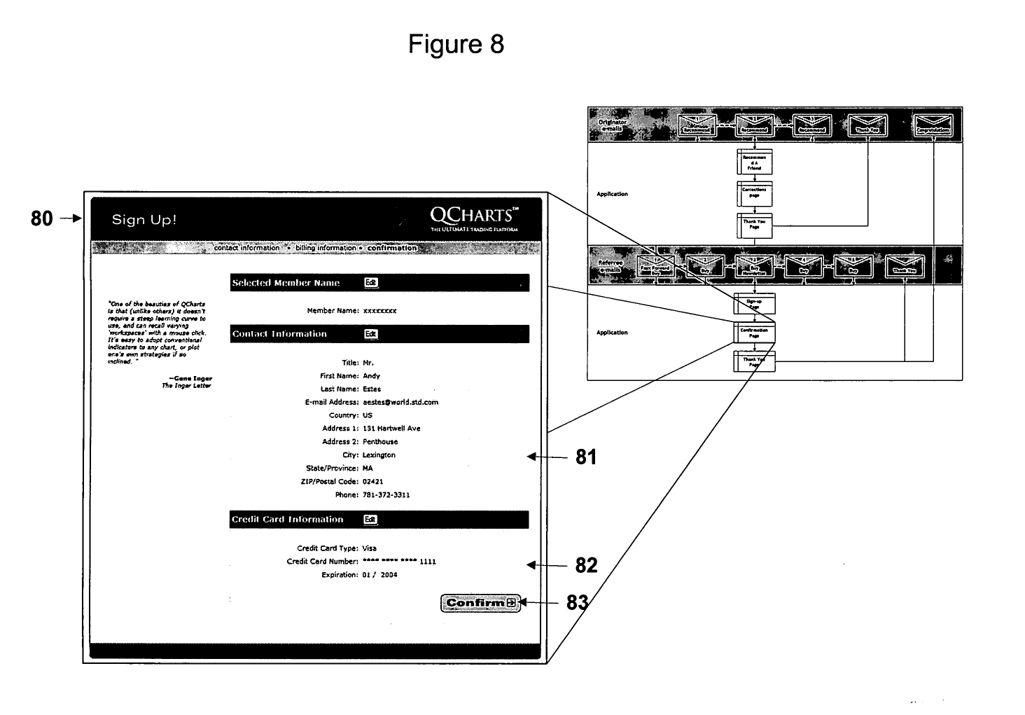

In the event the Referree submits the requested information, a summary communication may be transmitted (Step 16 of FIG. 1) to the Referree prior to completion of the participation process by the Referree in the event. An illustration of a summary communication 80 is provided in FIG. 8. The communication 80, in accordance with one embodiment of the present invention, may be formatted to provide a contact summary 81 of the Referree detailed contact information, along with a payment summary 82 of the Referree payment option. The communication 80 may also provide a confirmation link 83 to permit the Referree an opportunity to confirm the summary information before completing the process for participation.

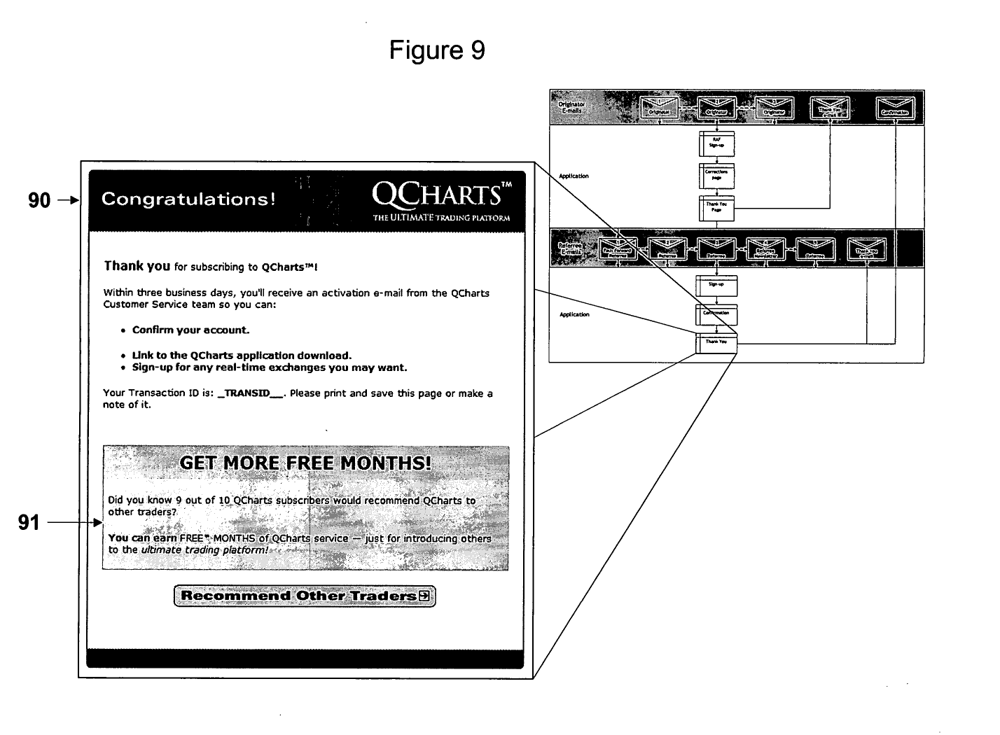

Once the confirmation is submitted by the Referree, and upon completion of the participation process by the Referree, a confirming communication may be transmitted (Step 17 of FIG. 1) to the Referree thanking the Referree for his participation in the event. As shown in FIG. 9, a “Thank You” may be provided within confirming communication 90 when transmitted to the Referree. The communication 90 may include, among other things, an offer 91, providing the Referree with an opportunity to become an Originator should the Referree submits contact information associated with new referree recipients.

A confirmation of the participation by the Referree in the invited event may also be transmitted (Step 18 in FIG. 1) to the Originator to notify the Originator of such a participation. As a result of the participation by the Referree, the Originator may now be eligible to receive a redeemable reward. A reward can be any convertible or fungible good or service of value to the Originator.

Feedback Loops

In accordance with one embodiment of the present invention, feedback loops may be provided as they confer the ability to conserve and reinvest energy in the referral economy.

There can be a plurality of feedback loops along the referral process of the present invention. One purpose of a feedback loop may be to drive the number of referrals provided by a given Originator. To that end, notifications may be transmitted to the Originators so as to notify the Originators of the Referree's progress towards participation in an event, as such participation can result in the Originator receiving a redeemable reward. Such notifications can also present an updated scoreboard to the Originator, stimulating him to refer again and reminding him of the value of his referrals. The notifications employed in the referral process of the present invention may vary in time, content and overall value based on business models and the supervision of the control model (See FIG. 11).

Referrees Become Originators

Another feedback loop that can be central to the referral process of the present invention may the ability for any Referree to immediately progress from being a Referree to an Originator referring, even on an accrual basis, new Referrees. In the case of a trial-driven conversion between being “Referree” and “Referree Newcustomer” the presence of accrued payables can a powerful lever to stem trial attrition.

### EXAMPLES

It will be expressly understood that the examples provided are merely representative of the possible embodiments of the present invention, and that these examples are the illustrative of the far greater range of formats which are potentially possible and useful within the present invention.

Sale of a Consumer Product/Service

An example of the application of the referral process in accordance with an embodiment of the present invention can be illustrated in connection with the sale of a consumer product/service.

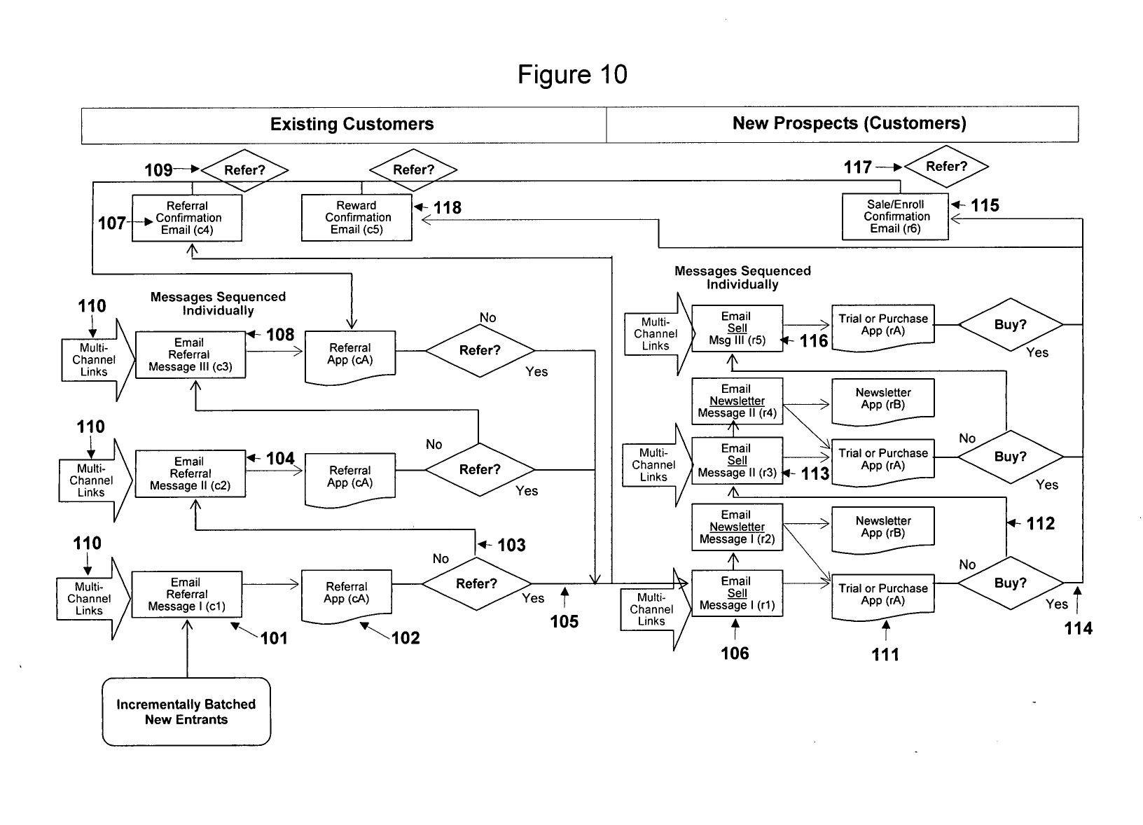

Referring now to FIG. 10, an Originator (i.e., Existing Customer side) may receive an electronic message 101 for referral from the system of the present invention. Once the message 101 has been directed to the Originator, the system waits for a response, e.g., a referral application action 102, from the Originator. In the event no response 103 occurs (e.g., read but no referrals or not read), the system generates a follow-on message 104 again inviting the Originator to make a referral. Such a message may emphasize the potential reward to the Originator should the referral results in the participation of a Referree in the invited event. In the event a response occurs 105, if the contact information for the Referree turns out to be valid, the system proceeds to transmitting an email message 106 to the Referree (i.e., New Prospects side) and a confirmation message 107 may be sent to the Originator of the message forwarded to the Referree. If the contact information for the Referree turns out to contain incorrect data or the contact information already exists in the database, the system generates a follow-on message 104, which in this case, notifies the Originator of the error or duplication, and encourages the Originator to update the contact information.

It should be noted that if a particular Referree, including that from the updates or corrections, has been referred by a number of Originators, as concurrent referrals are accumulated, the system notes such an occurrence and inputs the occurrence into its control models (e.g., the data+the rules+the models). The presence of multiple independent referrals, places an increasing weight, and therefore an increasing bounty on the acquisition of such a Referree. This is because that particular Referree, once he becomes Originator, on average, can refer more people who know more people, adding significantly more generational energy to the referral economy.

In response to the follow-on message 104, if no action (e.g., read but no referrals or not read) occurs on the part of the Originator, another follow-on message 108 may be generated again inviting the Originator. Again, such a message may emphasize the potential reward to the Originator should the referral results in the participation of a Referree in the invited event. In the situation where the system requests an update on the contact information in the follow-on message 104, if an update occurs and the resulting contact information turns out to be valid, the system can proceed to transmitting an email message 106 to the Referree (i.e., New Prospects side) and a confirmation message 107 may be sent to the Originator of the message forwarded to the Referree.

In response to message 108, if the Originator provides contact information of Referrees that turns out to be valid, the system can proceed to transmitting an email message 106 to the Referree (i.e., New Prospects side) and a confirmation message 107 may be sent to the Originator of the message forwarded to the Referree. If no response from the Originator occurs, the system may remain in the “sticky state” and several additional rounds of follow-on messages may continue until a positive response results from the Originator.

In connection with the referral confirmation 107, the system may provide the Originator with another opportunity to make new referrals 109 and the process may be re-initiated as discussed above starting with message 101. It should be appreciated that the system of the present invention, in one embodiment, may employ multiple communications channels 110 at various intervals to transmit to an Originator an invitation to make referrals.

Looking now at the New Prospects side of FIG. 10, once message 106 has been forwarded to the Referree, for instance, a “faux-forward” message, the system awaits for a response, e.g., a participation application action 111, from the Referree. In the event no response 112 occurs (e.g., read but no action, or not read), the system generates a follow-on message 113 again inviting the Referree to make participation in the invited event. Such a message may emphasize the potential reward to the Referree should the Referree participates in the invited event. In the event a response occurs 114 resulting in participation of the Referree in the event, the system proceeds to subsequently transmit a confirmation message 115 to the Referree confirming his participation in the invited event.

In response to the follow-on message 113, if no action (e.g., read but no action, or not read) occurs on the part of the Referree, another follow-on message 116 may be generated, for instance, a “non-faux-forward” message, again inviting the Referree to participate in the event. Again, such a message 116 may emphasize the potential reward to the Referree should the Referree participates in the invited event. If a positive response from the Referree occurs, resulting in participation by the Referree in the event, the system can proceed to subsequently transmit a confirmation message 115 to the Referree confirming his participation in the invited event.

Still looking at FIG. 10, in response to follow-on message 116, if the Referrees provides a positive response, which results in participation by the Referree in the event, the system can proceed to transmit a confirmation message 115 to the Referree confirming his participation. If no response from the Referree occurs, the system may remain in the “sticky state” and several additional rounds of follow-on messages may continue until a positive response results from the Referree.

In connection with the confirmation message 115, the system may provide the Referree with an opportunity to make referrals 117, in which case the Referree becomes an Originator. The process illustrated in FIG. 10, may thereafter be re-initiated as discussed above starting with message 101 on the Existing Customers side. In addition to the confirmation message 115 to the Referree, the system may also generate a reward confirmation message 118 to the Originator, notifying the Originator of the participation by the Referree in the event. In connection with such message 118, the system informs the Originator of the redeemable reward accrued by the Originator as a result of the Referree's participation in the event. It should be appreciated that the system of the present invention, in one embodiment, may employ multiple communications channels 119 at various intervals to transmit to the Referree an invitation to make participate the event.

Business-to-Business Consultative Interaction

The referral process of the present invention, in an alternative embodiment, can be applicable to business-to-business consultative activities. Such a scenario may be worthwhile when relatively high price points, relatively hard to configure or hard to describe product of service offerings, e.g., consulting services, are involved. Selling such offerings generally requires a rigorous, relatively long process that involves multiple tactics, communication channels and a comparatively high amount of total sales investment to close. Moving step-wise through a classical sales process can be a big investment for a Seller. Likewise, a Buyer may not be alone in the journey. The Buyer may be accompanied by members of a decision-making committee who may be following a model that involves recommenders, approvers and other contributors, due to the size and, perhaps, the comparatively high degree of customization that may be required to tailor the base offering to the context of a specific business model or situation. The impact of such referral economy can be profound and the need for a critical mass of “energy” may be crucial in the maintenance of a critical mass necessary to self-perpetuate. This “energy”, in one embodiment, may include an Originator activity stimulating a Referree activity within a finite amount of time, causing feedback loops to then fire, and re-energizing the Originator with reports of a referred Referree, leading to an occurrence that results in a payable-event. If the frequency of the back-and-forth communication and, implicitly, the interval of such communication, is not at or beyond a threshold, the referral economy, in this business-to-business model, will tend towards collapse rather than growth or oscillation (i.e., states where the value may be the highest).

In applying this business-to-business scenario to the referral process employed in accordance with one embodiment of the present invention, the distinguishing characteristics of such a scenario become clear. An Originator may now be one of several characters. These various Originator characters may differ in buying behavior, in membership within a relatively large or relatively small company with relatively large or small budgets, and relatively big or small appetites for purchase of the product or service being referred. Likewise, a Referree in a business-to-business scenario may now be one of several characters. These Referrees may be various characters in a larger committee charged with participating, for instance, in the purchases of products or services. Therefore, to maintain and accelerate the energy in the referral economy in accordance with one embodiment of the present invention, events-payable to which a Referree commits and for which Originator may be rewarded can be pulled forward probabilistically, such that the Originator may be notified regarding the one-to-many significant movements by a Referree or Referree company towards the close of a deal.

For example, the system of the present invention and its program may pay, for instance, 1/100th of the allowable acquisition cost for a behavior attributed to a Referree in a move from familiarity to consideration phase (e.g., enrollment in a seminar or webinar). Likewise, the system of the present invention may pay, for example, 1/10th for a move by a Referree from the consideration phase to the trial phase, and so-on, as illustrated in the New Prospects side of FIG. 10. However, it should be noted that the system does not just pay an Originator for a Referree activity. Rather, multiple Referrees along the decision process may be rewarded. Implementations of this reward model emanate from the learning control model (e.g., systems, rules, rule-chains, expert systems, rule processors, analytical models-both linear and non-linear). In other words, the system may be designed to identify and value each Referree, as each Referree reveals himself to be one of several participants in a committee that may be involved in the decision-making process. The system of the present invention may also vary its valuation of various participants based on a number of factors, for example, being the approver (more valuable) versus the recommender (less valuable). Other coefficients of value may be captured and applied by the system in implementing the referral process.

It should be noted that in connection with the above discussion of a customized personal URL, an alternate form of URL may be provided for use in the referral process of the present invention. In particular, an affiliate URL may be provided as an independent promotional contributor of sales-side input to a systematically identified and developed distribution channel. For example, desirable affiliates might include on their websites, in a scenario where, for instance, a financial services software product may be sold, accomplished traders who publish for-sale newsletters or provide paid FA advice. These powerful expert recommenders may be in a position to create a number of Referree's. The system of the present invention recognizes this and rewards these recommenders special premium rewards, for instance, cash.

Equivalents

From the foregoing detailed description of the invention, it should be apparent that the for the creation of a relationship marketing database based on direct-response programming have been described resulting in improved relationship marketing approaches. Although particular embodiments have been disclosed herein in detail, this has been done by way of example for purposes of illustration only, and is not intended to be limiting with respect to the scope of the appended claims which follow. In particular, it is contemplated by the inventor that substitutions, alterations, and modifications may be made to various features of the invention without departing from the spirit and scope of the invention as defined by the claims. For instance, although the examples provided above are directed at an individual-to-individual scenario and at a business-to-business scenario, it is contemplated that an individual-to-corporate entity scenario may also be adapted within the framework of the referral process of the present invention.

1. A method for generating referrals, the method comprising:
transmitting to a participating recipient an electronic message that contain therein an incentive so as to encourage the participating recipient to provide contact information of at least one referree recipient having an identified interest similar to that of the participating recipient;
generating, based on the response from the participating recipient, a database of contact information of referree recipients;
forwarding to each referree recipient an electronic message formatted to appear as a message from the participating recipient with an invitation to participate in an event for which the participating recipient is a participant.

2. A method as set forth in claim 1, wherein in the step of transmitting, the incentive includes allocating to the participating recipient a redeemable reward upon participation by the referree recipient in the event.

3. A method as set forth in claim 2, further including notifying the participating recipient of the reward upon participation by the referree recipient in the event.

4. A method as set forth in claim 1, wherein the step of generating further includes validating the contact information of the referree recipients.

5. A method as set forth in claim 4, wherein the step of validating includes excluding from the database contact information of a referree recipient currently in the database.

6. A method as set forth in claim 4, wherein the step of validating includes excluding from the database contact information of a referree recipient that contains incorrect data.

7. A method as set forth in claim 6, further including:
sending to the participating recipient a list of contact information that has been excluded from the database; and
allowing the participating recipient an opportunity to update the contact information of the referree recipients excluded from database, so that the referree recipient can be afforded another opportunity to be invited to participate in the event for which the participating recipient is a participant.

8. A method as set forth in claim 7, wherein the step of allowing includes transmitting to the participating recipient a message containing therein an incentive so as to encourage the participating recipient to update the contact information of excluded referree recipients.

9. A method as set forth in claim 1, further including
identifying a referree recipient who, in response to the invitation, participated in the event; and
transmitting to the identified referree recipient a message that contained therein a reward redeemable upon participation by other referree recipients in the event, so as to encourage the identified referree recipient to provide contact information of those other referree recipients having a similarly identified interest.

10. A method as set forth in claim 1, further including providing in a message forwarded to the participating recipient, an electronic link associated with the participating recipient, such that access of the link by a referree recipient who subsequently partakes in the invited event results in a reward for the participating recipient.

11. A method as set forth in claim 1, wherein in the step of providing, the electronic link is a universal resource locator.

12. A method as set forth in claim 1, wherein the message to the participating recipient and the referree recipient includes an electronic mail message, an electronic advertisement or other electronic communications.

13. A method as set forth in claim 1, further including sending a follow-on message to the referree recipient to encourage the referree recipient to participate in the event for which the participating recipient is a participant.

14. A method for generating referrals, the method comprising:
transmitting to a participating recipient an electronic message that contain therein an incentive so as to encourage the participating recipient to provide contact information of at least one referree recipient having an identified interest similar to that of the participating recipient;
forwarding to a referree recipient an electronic message formatted to appear as a message from the participating recipient with an invitation to participate in a first of a series of events; and
sending to a referree recipient a subsequent message with an invitation to participate in the next sequential event upon participation of the referree recipient in the first event.

15. A method as set forth in claim 14, wherein in the step of transmitting, the incentive includes allocating to the participating recipient a redeemable reward upon participation by the referree recipient in the event.

16. A method as set forth in claim 15, further including notifying the participating recipient of the reward upon participation by the referree recipient in each of the series of events.

17. A method as set forth in claim 14, further includes:
generating a database of contact information; and
validating the contact information of the referree recipients.

18. A method as set forth in claim 17, wherein the step of validating includes excluding from a database contact information of the referree recipient currently in the database.

19. A method as set forth in claim 17, wherein the step of validating includes excluding from the database contact information of the referree recipient that contains incorrect data.

20. A method as set forth in claim 19, further including:
sending to the participating recipient a list of contact information that has been excluded from the database; and
allowing the participating recipient an opportunity to update the contact information of those referree recipient excluded from database, so that the referree recipient can be afforded another opportunity to be invited to participate in the event for which the participating recipient is a participant.

21. A method as set forth in claim 20, wherein the step of allowing includes transmitting to the participating recipient a message containing therein an incentive so as to encourage the participating recipient to update the contact information of excluded referree recipients.

22. A method as set forth in claim 14, further including
identifying a referree recipient who, in response to the invitation, participated in the event; and
transmitting to the identified referree recipients a message that contained therein a reward redeemable upon participation by other referree recipients in the event, so as to encourage the identified referree recipient to provide contact information of those other referree recipients having a similarly identified interest.

23. A method as set forth in claim 14, further including providing in the message forwarded to the referree recipient, an electronic link associated with the participating recipient, such that access of the link by the referree recipient who subsequently partakes in the invited event results in a reward for the participating recipient.

24. A method as set forth in claim 14, wherein in the step of providing, the electronic link is a universal resource locator.

25. A method as set forth in claim 14, wherein the message to the participating recipient and the referree recipient includes an electronic mail message, an electronic advertisement or other electronic communications.

26. A method as set forth in claim 14, wherein the step of forwarding further includes an electronic mail message to the referree recipient which encourages or motivates the referree recipient to participate in an event for which the participating recipient is currently involved.

27. A method as set forth in claim 14, further including sending a message to referree recipient of the invitation for participation in a first of a series of event an offer for allocating to such a referree recipient a redeemable reward upon participation in the next sequential event in the series.

28. A method as set forth in claim 27, further including notifying the referree recipient of the reward upon participation of the next sequential event in the series.

29. A method as set forth in claim 27, wherein the referree recipient may be multiple in number, each with an ability to accept an invitation for a specific event in the series of event.

30. A method for generating referrals, comprising the steps of:
(a) recruiting a participating recipient by transmitting an electronic message to the participating recipient that offers a reward for providing the contact information of a referree recipient who subsequently becomes a participant in an invited event;
(b) capturing contact information of the referree recipient provided by the participating recipient in a referree database;
(c) excluding from the referree database the contact information of the referree recipient that is currently in the referree database, that is not identified as a valid electronic mail address, and that is a duplicate referral, or a combination thereof;
(d) transmitting to the participating recipient a message having the invalid contact information identified in step c;
(e) transmitting to the participating recipient a calculated potential value of for those referree recipient whose contact information is not excluded from the referree database;
(f) transmitting a message to the referree recipient that is formatted to appear as a forward message from the participating recipient so as to solicits participation by the referree recipient in an invited event;
(g) sending a message to the referree recipient in response to his participation in the invited event;
(h) transmitting a notification to the participating recipient in response to the participation by the referree recipient in the invited event; and
(i) informing the participating recipient of a redeemable reward resulting from participation by the referree recipient in the invited event.

31. A method as set forth in claim 30, wherein the reward includes any convertible or fungible good or service of value to the participating recipient.

32. A method as set forth in claim 30, wherein the reward includes one of cash, a cash credit, a discount credit for subsequent purchase of a product or service, or any combination thereof.

33. A method as set forth in claim 30, wherein the participating recipient is an individual, an entity, or combination thereof.
